(19) United States
(12) Patent Application Publication
(10) Pub. No.: US 2023/0022233 A1
(43) Pub. Date: Jan. 26, 2023

(54) Measuring Assembly with at least two Measuring Devices and Method for Operating such a Measuring Assembly

(71) Applicant: VEGA GRIESHABER KG, Wolfach (DE)

(72) Inventors: Winfried Rauer, Fischerbach (DE); Ralf Schaetzle, Fischerbach (DE); Juergen Haas, Oberwolfach (DE); Fabian Rank, Wolfach (DE); Natalie Waldecker, Ortenberg (DE)

(21) Appl. No.: 17/749,963

(22) Filed: May 20, 2022

(30) Foreign Application Priority Data
Jun. 2, 2021 (DE) 10 2021 114 377.2

(51) Int. Cl. G01F 23/80

(52) U.S. Cl. CPC G01F 23/802

(57) ABSTRACT

A measuring assembly with at least two measuring devices and a higher-level unit, characterized in that the measuring assembly further has a network distributor, wherein the measuring devices are connected to the network distributor via a two-wire Ethernet connection, the measuring devices are fully supplied with power via the two-wire Ethernet connection, and the network distributor is connected to the higher-level unit with an Ethernet connection.

### CROSS REFERENCE TO RELATED APPLICATIONS

This patent application claims priority to German Patent Application 102021114377.2, filed on Jun. 2, 2021.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a pressure sensor with a compensation unit and a method for compensation.

### Background of the Invention

Standard commercial measuring devices in the sector of filling level measurement technology compute measurement results directly on-site, i.e. in the measuring device itself Frequently, a small microcontroller system with a limited power requirement and limited computing capacities is provided in the measuring device for computing these target measurement values, i.e. the measurement results that are of actual interest.

Because the determination of the target measurement values, in measuring systems employing radar technologies or other radio technologies, for example, generally entails the acquisition of a so-called echo curve, and this echo curve may possibly include many value-discrete and time-discrete data points or basic values, computation may often require a large computing effort. A large computing effort arises because the echo curves have to be processed using correspondingly complex algorithms in order to arrive at the target measurement values. This large computing effort results in a limited number or computations per second and a very static behavior of the measuring device, particularly with regard to application cases with special features in the echo curve. In this case, use is often made of a corresponding parameterization on-site, i.e. an adaptation of parameters, a setting of parameters (setting parameter) or an adjustment of parameters (parameter adjustment), so that the measuring device is capable of functioning appropriately under the given circumstances.

In the case of radiometric measurements, raw count rates of different radiometric measuring devices are combined and a single measured quantity, e.g. a filling level, a density, a density profile or the position of a phase boundary, is calculated therefrom. In the prior art, a separate physical communication channel is set up for this purpose between the various sensors, via which the radiometric measuring devices communicate with one another, i.e., a separate cable is installed as a communication line between the sensors. In this case, a radiometric measuring device serves as a master that retrieves the measurement values from the slave measuring devices. In addition to these communication lines, a separate voltage supply, i.e. another cable with at least two lines, is required for each sensor. This results in a large wiring requirement which is perceived as disadvantageous.

A schematic representation of such a measuring assembly 90 in accordance with the prior art is schematically depicted, by way of example, in FIG. 1.

The measuring assembly 90 shown in FIG. 1 basically has 3 radiometric measuring devices 81, 82, 83, e.g. radiometric density measuring devices. Each of the radiometric measuring devices 81, 82, 83 is connected to a power supply unit 91 via a power supply cable 92. In the present case, the power supply unit 91 is configured as a common power supply unit for the three radiometric measuring devices 81, 82, 83, but may also be configured as three separate power supply modules that may be arranged in a decentralized manner. In order to accomplish a communication between the measuring devices 81, 82, 83, e.g. of raw data of the respective measurements for computing a combined measurement value (determined from all the measurements), they are each connected to one another via a communication line 93. In the exemplary embodiment shown here, the communication line 93 is routed from a first measuring device 81 to a second measuring device 82 and from there to a third measuring device 83.

From the third measuring device 83, another communication line 94 finally leads to a higher-level unit 3, which is disposed in a control room, for example.

It may be remarked at this point that the measuring devices may also be arranged at significant distances from one another, so that a not inconsiderable wiring requirement may result. This wiring requirement arises also with regard to the supply of power. For applications in regions that are subject to explosion hazards, it is also necessary to provide explosion-protected cable feed-through devices for each of the above-mentioned cables. Thus, each of these cables constitutes a potential source of error and requires considerable effort both in designing the measuring devices, in the installation of the measuring assembly and in the operation, e.g. for service and maintenance. This effort means increased costs for the operator of the measuring assembly for both acquisition and running operation.

The use of a programmable logic controller (PLC) constitutes a second variant. For example, two-wire sensors with 4-20 mA may be connected thereto. In order to compute the measurement value in this variant, the required computations need to be programmed into the control unit. Also, the 4-20 mA signals need to be scaled in accordance with the physical measuring quantity. Thus, the overall system becomes more complicated for the user during commissioning. Though the wiring requirement is reduced, it becomes more expensive due to the additionally required programmable logic controller. This is also perceived as disadvantageous.

It is therefore the object of the present invention to develop a measuring assembly with measuring devices and a method for operating such a measuring assembly further in such a manner that it is reduced, with regard to costs and effort, as compared with the prior art.

This object is achieved with a measuring assembly and method of operation having the features and steps, respectively, as described herein.

### BRIEF SUMMARY OF THE INVENTION

In a preferred embodiment, a measuring assembly (1) with at least two measuring devices (21, 22, 23) and a higher-level unit (3), characterized in that the measuring assembly (1, 90) further has a network distributor (5), wherein the measuring devices (21, 22, 23) are connected to the network distributor (5) via a two-wire Ethernet connection (7), the measuring devices (21, 22, 23) are fully supplied with power via the two-wire Ethernet connection (7), and the network distributor (5) is connected to the higher-level unit (3) with an Ethernet connection (9).

In another preferred embodiment, the measuring assembly (1) as described herein, characterized in that the two-wire Ethernet connection (7) is configured as an Ethernet APL connection.

In another preferred embodiment, the measuring assembly (1) as described herein, characterized in that an IP-based communication takes place between the higher-level unit (3) and the network distributor (5) as well as between the network distributor (5) and the measuring devices (21, 22, 23).

In another preferred embodiment, the measuring assembly (1) as described herein, characterized in that the network distributor (5) is configured as an APL switch.

In another preferred embodiment, the measuring assembly (1) as described herein, characterized in that the APL switch (5) has an Ethernet uplink.

In another preferred embodiment, the measuring assembly (1) as described herein, characterized in that the APL switch is supplied with power by the higher-level unit (3) via an APL uplink.

In another preferred embodiment, the measuring assembly (1) as described herein, characterized in that the network distributor (5) has its own power supply unit (11, 91), particularly a mains adapter (11) for a mains-coupled power supply (11, 91).

In another preferred embodiment, the measuring assembly (1) as described herein, characterized in that the measuring devices (21, 22, 23) can be arranged in a region that is subject to explosion hazards, particularly in zone 0 according to Directive 2014/34/EU.

In an alternate preferred embodiment, a method for operating a measuring assembly (1) with at least two measuring devices (21, 22, 23) as described herein, characterized in that the measuring devices (21, 22, 23) are fully supplied with power via the two-wire Ethernet connection (7), and the at least two measuring devices (21, 22, 23), via the network distributor (5), communicate with one another and transmit at least one combined measurement value to the higher-level unit (3).

In another preferred embodiment, the method as described herein, characterized in that the measuring devices (21, 22, 23) communicate with one another in an IP-based manner.

In another preferred embodiment, the method as described herein, characterized in that at least one measuring device (21, 22, 23) transmits raw measurement data via the two-wire Ethernet connection (7) to another measuring device (21, 22, 23), in particular to a master device, and the other measuring device (21, 22, 23) processes its own raw measurement data and the transmitted raw measurement data into the combined measurement value and transmits it to the higher-level unit (3).

In another preferred embodiment, the method as described herein, characterized in that the higher-level unit (3) transmits additional information, in particular peripheral data, to at least one measuring device (21, 22, 23) via the two-wire Ethernet connection (7).

In another preferred embodiment, the method as described herein, characterized in that the at least one measuring device (21, 22, 23), preferably the master device as described herein takes into account the additional information in the processing of the raw measurement data.

### BRIEF DESCRIPTION OF THE DRAWINGS

FIG. 1 is a schematic representation of a measuring assembly in accordance with the prior art.

FIG. 2 is a schematic representation of a measuring assembly according to the present application.

### DETAILED DESCRIPTION OF THE INVENTION

A measuring assembly with at least two measuring devices and a higher-level unit is characterized in that the measuring assembly further has a network distributor, wherein the measuring devices are connected to the network distributor via a two-wire Ethernet connection, the measuring devices are fully supplied with power via the two-wire Ethernet connection, and the network distributor is connected to the higher-level unit with an Ethernet connection.

Thus, the measuring assembly according to the invention is characterized in that the measuring devices are connected and supplied with power via an Ethernet connection. Due to the fact that both power supply and communication takes place via one and the same line, only one line per measuring device is required, which significantly reduces the wiring requirement. Via the network distributor, the measuring devices can communicate with the higher-level unit but also with one another, so that a single or several measuring devices can, for example, use raw data of other measuring devices and/or additional information provided by the higher-level unit for its own measurement value determination. Optionally, the Ethernet connection between the network distributor and the higher-level unit may also be realized in a wireless manner.

For example, the measuring devices may be configured as radiometric measuring devices, wherein the measuring device exchange raw measurement data amongst one another, or at least one radiometric measuring device receives raw measurement data of another radiometric measuring device and/or additional information from the higher-level unit and also takes them into account in the measurement value determination. During the measurement value determination, a radiometric measuring device, for example, can thus process its own raw measurement data and the raw measurement data of at least one other radiometric measuring device and/or the additional information provided by the higher-level unit.

In the case of at least one measuring device being configured as a radiometric measuring device, it can thus be achieved that, for example, it also processes the raw measurement data of another radiometric measuring device and that thus, the radiation of another source or a background radiation, for example, are taken into account. Additionally or alternatively, the higher-level unit may provide additional information, e.g. regarding the background radiation. Thus, the quality and reliability of the obtained measurement values can be increased significantly.

In the one measuring device—irrespective of the example of a radiometric measuring device—additional data of an external nature, i.e. in particular data of another measuring device and/or of the higher-level unit, are thus processed during the measurement value determination, i.e. during the computation of the measurement value. Though a computing effort in the measuring device processing the additional data is increased thereby, it is accomplished, however, that an elaborate programming of a control unit or of a common evaluation device can be avoided.

Alternatively, the measuring devices may also be configured as pressure measuring devices. In this case, for example, a pressure measuring device may also take into account, in the measurement value determination, the pressure measurement data of another pressure measuring device and/or additional information provided by the higher-level unit.

The wording that measurement data of another measuring device or additional information are also taken into account in the measurement value determination means, in particular, that they are also processed in the computation of a measurement value outputted by the measuring device, i.e., in particular, that they are processed as an input value in an algorithm for the computation of a measurement value. The measuring device to which the additional measurement data and/or additional information are provided thus performs additional computing operations as compared with a situation in which these additional measurement data and/or additional information are not available.

The two-wire Ethernet connection may preferably be configured as an Ethernet APL connection. Ethernet APL permits a two-wire-based power supply and communication of the field devices with the higher-level unit, but also with one another. Ethernet APL also permits the configuration of the measuring devices in an intrinsically safe manner, so that they can also be used in regions that are subject to explosion hazards.

Communication via the Ethernet APL connection may take place in an IP-based manner between the higher-level unit and the network distributor as well as between the network distributor and the measuring devices. An IP-based communication is advantageous in that the measuring devices are uniquely identifiable due to the IP address and are able to communicate with one another in a rapid and effective manner.

Advantageously, the network distributor is configured as an APL switch. Such an APL switch is capable of supplying the connected measuring devices with power and of distributing the individual data packets. In this case, the APL switch may also be supplied with power via APL, e.g. by the higher-level unit via an APL uplink. Thus, the APL switch may optionally include an APL uplink and advantageously be supplied with power through that.

Alternatively, the APL switch may have a pure Ethernet uplink. Particularly in this case, the APL switch may have its own power supply in the form of an internal or external mains adapter for the mains-coupled power supply of the switch. However, the APL switch may also have an additional mains adapter in the case in which the switch itself is supplied with power via APL. This may be necessary, for example, if the power supply of the APL switch via Ethernet APL is not dimensioned for a sufficient supply of the connected measuring devices.

In a preferred embodiment, the measuring devices are configured in such a way that they can be arranged in a region that is subject to explosion hazards, particularly in zone 0 according to Directive 2014/34/EU (ATEX). This means that the measuring devices can be arranged in a region in which an explosive atmosphere consisting of a mixture of air with combustible substances in the form of gas, vapor or a mist is present permanently or over a long period of time, without the measuring device posing a risk for explosion.

A method according to the invention for operating a measuring assembly with at least two measuring devices according to any one of the preceding claims is characterized in that the measuring devices are fully supplied with power via the two-wire Ethernet connection, and the at least two measuring devices, via the network distributor, communicate with one another and transmit at least one combined measurement value to the higher-level unit.

Via the two-wire Ethernet connection, the measuring devices can exchange raw data, and at least one of the measuring devices can determine a combined measurement value and transmit it to the higher-level unit. Thus, it can be accomplished that the measurement value is determined in one of the measuring devices, and that a separate PLC can be omitted.

At least one measuring device receives raw measurement data of another measuring device and/or additional information from the higher-level unit and takes them into account in the measurement value determination. During the measurement value determination, a radiometric measuring device, for example, can thus process its own raw measurement data and the raw measurement data of at least one other radiometric measuring device and/or the additional information provided by the higher-level unit.

Preferably, the measuring device communicate with one another in an IP-based manner. This permits a rapid and efficient communication of the measuring devices with one another and, preferably, with the higher-level unit. Via the two-wire Ethernet connection, the higher-level unit may provide additional information or peripheral data, e.g. regarding the current date and time, or regarding a background radiation, and transmit them to at least one of the measuring devices. The measuring device may also process this additional information when determining the measurement value, so that the measuring accuracy of the individual measuring device and the overall measuring assembly can be improved in this way.

In a refinement of the method, at least one measuring device transmits raw measurement data to another measuring device, in particular a master device, via the two-wire Ethernet connection. The other measuring device processes its own raw measurement data and the transmitted raw measurement data into the combined measurement value and transmits the latter to the higher-level unit.

Thus, the combined measurement value is computed in one of the measuring devices, so that an elaborate programming of a control unit is not required. For this purpose, it is necessary for the measuring device performing the computation of the combined measurement value to have a sufficient computing capacity.

In a refinement of the method, the at least one measuring device, preferably the master device, takes into account the additional information in the processing of either exclusively its own, or of its own and the transmitted, raw measurement data.

Due to the present invention, the wiring requirement in the measuring assembly is reduced, because the individual measuring devices are connected to a field switch only via a two-wire line, and both communications and voltage supply are carried out via this two-wire line. Through Ethernet and the communication layers based thereon, the continuous communication between the individual measuring devices is possible without having to provide an additional physical channel. Thus, the measuring devices can exchange with one another their raw measurement data for determining the measuring quantity. The effort for wiring is reduced by the star topology, which in turn results in cost savings. By omitting the separate voltage supply unit and the smaller number of lines also facilitates the installation of the measuring devices in explosion-prone regions.

### DETAILED DESCRIPTION OF THE FIGURES

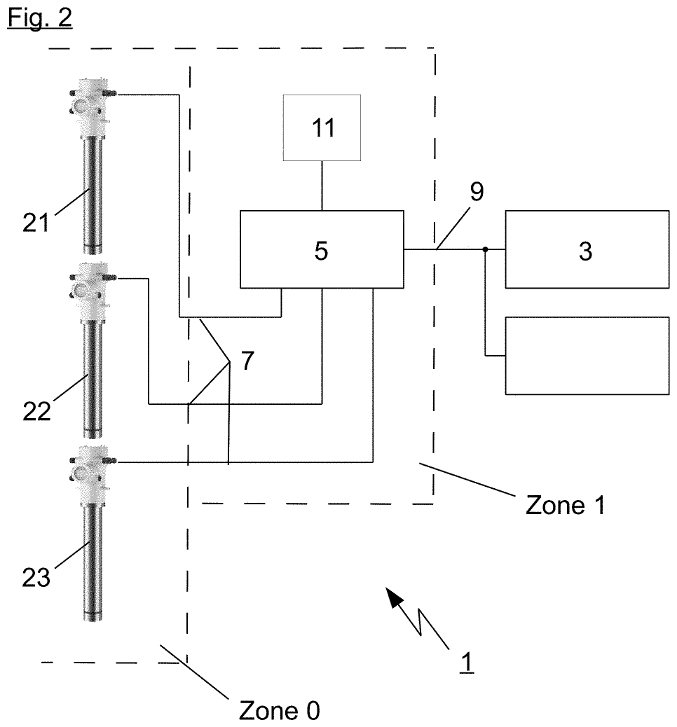

FIG. 2 shows a schematic representation of a measuring assembly 1 according to the present application.

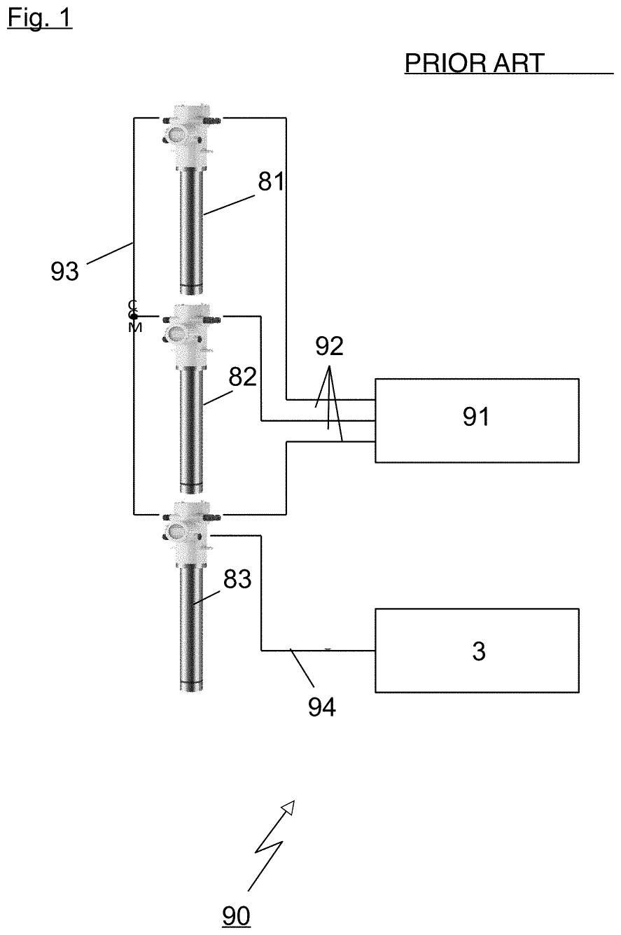

The measuring assembly 1 according to FIG. 1 is substantially formed from three measuring devices 21, 22, 23, which are connected, in a star topology, to a network distributor 5 configured as an Ethernet APL field switch by means of two-wire Ethernet connections 7. Both a power supply and communication with the measuring devices 21, 22, 23 take place via the two-wire Ethernet connections 7.

The two-wire Ethernet connection is configured as an Ethernet APL connection, which permits an Ethernet communication with as well as a power supply to the measuring devices 21, 22, 23 via two physical lines—i.e. a two-wire line. The supply of power, i.e. the feed of power to the two-wire line, takes place in the network distributor 5, which is configured in accordance with Ethernet APL (APL=Advanced Physical Layer). Ethernet APL is a special 2-wire Ethernet based on 10BASE-T1L in accordance with IEEE 802.3cg.

In the present exemplary embodiment, the network distributor 5 has a separate, external power supply unit 11, which is configured as a mains adapter and which supplies the network distributor 5 with the necessary power for its own operation and for supplying power to the measuring devices 21, 22, 23.

The network distributor is connected to a higher-level unit 3 via an Ethernet connection 9. Depending on the requirements of the respective case of application, the Ethernet connection 9 may be configured as an Ethernet, fast Ethernet, gigabit Ethernet, or wirelessly, as a WLAN connection, for example. In addition to the higher-level unit 3, a service station 13, e.g. in the form of a service PC, is also connected to the network distributor 5. Thus, the service station 13 can monitor the status of the entire measuring assembly 1 and configure the various measuring devices 21, 22, 23 without having to establish a direct physical link to the respective sensors/measuring devices 21, 22, 23.

Due to the Ethernet APL connection 7, the measuring devices 21, 22, 23 are configured in an intrinsically safe manner and may thus be arranged in zone 0, according to Directive 2014/34/EU (ATEX), of a region that is subject to explosion hazards. In the present exemplary embodiment, the network distributor 5 is configured as a field switch and configured in such a manner that it can be arranged in zone 1. The higher-level unit 3 and the service station 13 are arranged in zone 2.

Due to two-wire Ethernet communication solutions, such as Ethernet APL, a rapid Ethernet communication with 10 Mbit/s may take place simultaneously with a voltage supply to the measuring devices, into the region that is subject to explosion hazards (ex-region). Due to the communication of Ethernet APL, which is based on MAC addresses and IP addresses, the measuring devices can thus communicate with one another via the network and exchange their raw measurement data (raw data). From these raw data, one or more devices located in the network may then compute an overall measurement value, e.g. an overall filling level. Moreover, the measuring system may be supplied with additional information by the control system, i.e. the higher-level unit 3. Examples include, for example, the presence of external radiation, special process conditions, or the current date and time for a decay compensation. The determined overall measurement value may then be transmitted to the control system via two-line Ethernet communication.

### LIST OF REFERENCE NUMBERS

1 Measuring assembly
3 Higher-level unit
5 Network distributor
7 Two-wire Ethernet connection
9 Ethernet connection
11 Mains adapter/Power supply unit
13 Service station
21 First measuring device
22 Second measuring device
23 Third measuring device
81 First measuring device
82 Second measuring device
83 Third measuring device
90 Measuring assembly
91 Power supply unit
92 Power supply cable
93 Communication circuit
94 Further communication circuit

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

It must be noted that the features cited individually in the claims can be combined with each other in any technologically meaningful manner (also across the boundaries of categories, such as method and device) and represent other embodiments of the invention. The description, in particular in connection with the figures, additionally characterizes and specifies the invention.

It may also be noted that a conjunction “and/or” used hereinafter, which is situated between two features and links them to each other, should always be interpreted such that, in a first embodiment of the subject matter according to the invention, only the first feature may be provided, in a second embodiment, only the second feature may be provided, and in a third embodiment, both the first and the second feature may be provided.

We claim:

1. A measuring assembly with at least two measuring devices and a higher-level unit, characterized in that the measuring assembly further has a network distributor, wherein the measuring devices are connected to the network distributor via a two-wire Ethernet connection, the measuring devices are fully supplied with power via the two-wire Ethernet connection, and the network distributor is connected to the higher-level unit with an Ethernet connection.

2. The measuring assembly according to claim 1, wherein the two-wire Ethernet connection is configured as an Ethernet APL connection.

3. The measuring assembly according to claim 1, wherein an IP-based communication takes place between the higher-level unit and the network distributor as well as between the network distributor and the measuring devices.

4. The measuring assembly according to claim 1, wherein the network distributor is configured as an APL switch.

5. The measuring assembly according to claim 4, wherein the APL switch has an Ethernet uplink.

6. The measuring assembly according to claim 5, wherein the APL switch is supplied with power by the higher-level unit via an APL uplink.

7. The measuring assembly according claim 1, wherein the network distributor has its own power supply unit, particularly a mains adapter for a mains-coupled power supply.

8. The measuring assembly according to claim 1, wherein the measuring devices can be arranged in a region that is subject to explosion hazards, particularly in zone 0 according to Directive 2014/34/EU.

9. A method for operating a measuring assembly with at least two measuring devices according to claim 1, wherein the measuring devices are fully supplied with power via the two-wire Ethernet connection, and the at least two measuring devices, via the network distributor, communicate with one another and transmit at least one combined measurement value to the higher-level unit.

10. The method according to claim 9, the measuring devices communicate with one another in an IP-based manner.

11. The method according to claim 9, wherein at least one measuring device transmits raw measurement data via the two-wire Ethernet connection to another measuring device, in particular to a master device, and the other measuring device processes its own raw measurement data and the transmitted raw measurement data into the combined measurement value and transmits it to the higher-level unit.

12. The method according to claim 9, wherein the higher-level unit transmits additional information, in particular peripheral data, to at least one measuring device via the two-wire Ethernet connection.

13. The method according to claim 12, wherein the at least one measuring device is a master device that takes into account the additional information in the processing of the raw measurement data.
